(19) United States
(12) Patent Application Publication
(10) Pub. No.: US 2009/0328159 A1
(43) Pub. Date: Dec. 31, 2009

(54) Systems and Methods for Secure Printing

(75) Inventor: Qi Luo, Foster City, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/165,370

(22) Filed: Jun. 30, 2008

(51) Int. Cl. G06F 7/04

(52) U.S. Cl. 726/4

(57) ABSTRACT

Apparatus, systems, and methods consistent with disclosed embodiments provide for the secure printing of documents. A first security data is associated with a document, which is printed to one of several secure trays coupled to a printer, if a second security level derived from the first security data is not lower than the first security level currently associated with the secure output tray. The first security data is matched with second security data obtained from an input device coupled to the printer. Access to the secure tray is granted if the second security data matches a subset of the first security data. In some embodiments, secure output trays on the printer may be dynamically assigned to different security levels corresponding to the security levels of documents printed to the secure output trays.

### BACKGROUND

1. Field of the Invention

The present invention relates to the field of printers, and in particular to systems and methods for printing documents securely.

2. Description of Related Art

Computer printers, which are ubiquitous in most modern organizations, permit the quick printing of stored documents. Designers of modern printers have focused relentlessly on improving printer speed, efficiency, color accuracy, and cost resulting in virtually universal adoption of printers. Nevertheless, in order to optimize resource usage, most organizations use a network of high speed printers to serve people in the organization. Because these high speed printers may be accessed seamlessly over computer networks, most users served by a high-speed network printer will experience very little or no delay when printing documents. In addition, networking allows the system to be fault tolerant and permits users to switch to other printers when a printer malfunctions or demands service.

In most organizations, however, the use of a high-speed networked printing arrangement makes it difficult to print sensitive documents securely. For example, when payroll data or employee performance evaluations are printed, organizations often use dedicated printers in secure areas to prevent unauthorized access to the information. While the use of dedicated printers and/or secure areas may be feasible for large organizations, such an arrangement may be expensive and impractical for a smaller organization, or a satellite office of the large organization. In addition, the use of dedicated printers may reduce fault tolerance for critical printing applications because the vast majority of printers in the organization will be inaccessible and/or unavailable for securely printing such documents. Thus, there is a need for a simple, efficient, and easily deployable printing systems that facilitate the secure printing of documents.

### SUMMARY

In accordance with disclosed embodiments, apparatus, systems, and methods for securely printing documents are presented.

In some embodiments, a printer comprises at least one secure output tray coupled to the printer; at least one network port coupled to the printer, wherein the printer is capable of receiving at least one document and a first security data associated with the at least one document over the network port, and wherein the printer prints the received document to the secure output tray if a second security level derived from the first security data is not lower than the first security level.

Embodiments also pertain to a method for printing at least one document securely, wherein the method comprises associating a first security data with the document; transmitting the document and the first security data to a printer; and printing the document to at least one secure output tray coupled to the printer, if a second security level derived from the first security data is not lower than a first security level currently associated with the secure output tray.

These and other embodiments are further explained below with respect to the following figures.

### BRIEF DESCRIPTION OF THE DRAWINGS

FIG. 1 shows a block diagram of a system for securely printing documents.

FIG. 2 shows a flowchart describing an exemplary method for initialization of a system for secure printing.

FIG. 3 depicts a flowchart describing an exemplary method for securely printing documents.

FIG. 4 depicts an exemplary user interface showing user configurable options in a system for securely printing documents.

FIG. 5 shows a flowchart 500 depicting portions of an exemplary method to dynamically assign security levels to secure output trays.

FIG. 6 shows a flowchart 600 depicting portions of an exemplary method to dynamically assign security levels to secure output trays.

### DETAILED DESCRIPTION

In accordance with the present invention, systems and methods for securely printing documents are presented.

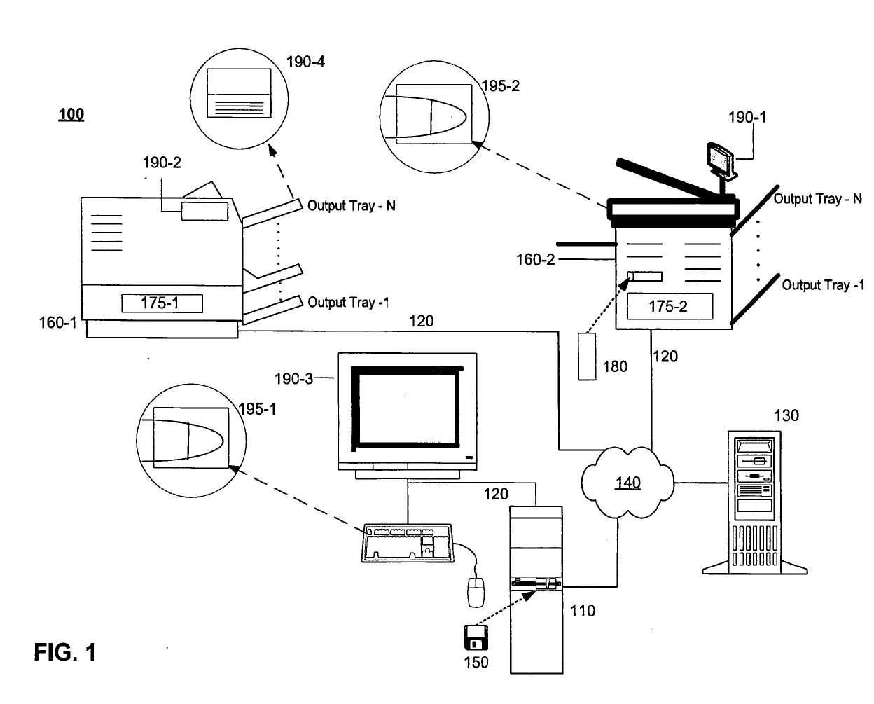

FIG. 1 shows a block diagram of exemplary system 100 for securely printing documents. A computer software application consistent with the present invention may be deployed on a network of computers and/or printers, as shown in FIG. 1, that are connected through communication links that allow information to be exchanged using conventional communication protocols and/or data port interfaces.

As shown in FIG. 1, exemplary system 100 includes a computer or computing device 110 and a server 130. Further, computing device 110 and server 130 may communicate over a connection 120, which may pass through network 140, which in one case could be the Internet. Computing device 110 may be a computer workstation, desktop computer, laptop computer, or any other computing device capable of being used in a networked environment. Server 130 may be a platform capable of connecting to computing device 110 and other devices too (not shown). Computing device 110 and server 130 may be capable of executing software (not shown) that allows the secure printing of documents on printers 160-1 and 160-2.

In some embodiments, computing device 100 may include a biometric identification device 195-1, which could be used to authenticate users and to regulate access to secured services and resources. For example, computing device 110 may include biometric identification device 195-1, which can be a fingerprint reader. Biometric identification device 195-1 may be used to read a fingerprint of the user's forefinger (or any other finger), which may then be compared with a stored fingerprint pattern for the user. If the fingerprints match, computing device 110 may allow the user to perform the requested action or access the requested resources. In some embodiments, the security data, such as the biometric information obtained by biometric identification device 195-1 may be associated with the object of the user's request and/or with the requested resources. For example, security information may be associated with a document being printed.

Printers 160 may be laser printers, ink jet printers, LED printers, plotters, multi-function devices, or other devices that are capable of printing documents. Computing device 110 may contain a removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with embodiments of the present invention. Portions of software applications may reside on removable media and be read and executed by computing device 110 using removable media drive 150. In some embodiments, intermediate and final results and/or reports generated by applications may also be stored on removable media.

Connection 120 couples computing device 110, server 130, and printers 160 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, SCSI, FIREWIRE, and/or BNC ports for transmission of data through the appropriate connection 120. The communication links could be wireless links or wired links or any combination that allows communication between computing device 110, server 130, and printers 160.

Network 140 could include a Local Area Network (LAN), a Wide Area Network (WAN), or the Internet. In some embodiments, information sent over network 140 may be encrypted to ensure the security of the data being transmitted. Exemplary printing device 160-2, may be a network printer, and can be connected to network 140 through connection 120.

System 100 may include multiple printing devices 160 and other peripherals (not shown), according to embodiments of the invention. Printing devices 160 may be controlled by hardware, firmware, or software, or some combination thereof. Printing devices 160 may include one or more print controller boards 175, such as exemplary print controllers 175-1 and 175-2, which may control the operation of printing devices 160. Printing devices 160 may be controlled by firmware or software resident on memory devices in print controllers 175. In general, print controllers 175 may be internal or external to print devices 160. In some embodiments, printing devices 160 may also be controlled in part by software, including print servers, or other software, running on computing device 110 or server 120.

Printing devices, such as exemplary printing devices 160, may also include consoles 190 such as consoles 190-1 and 190-2, or other interfaces to allow configuration options to be set, passwords and/or user identification and authentication information to be entered, and other messages to be displayed. In some embodiments, configuration options may be set or displayed using a display or user-interface on a monitor for a computer coupled to printing devices 160. For example, user interfaces to set one or more configuration options on printing device 160-1 may be displayed on monitor 190-3, which is coupled to computer 110. A user interface to set configuration options on printer 160-2 may also be displayed on monitor 190-3, using software running on server 130.

In some embodiments, configuration parameters pertaining to printing device 160 may be user-configurable. For example, the print resolution, document sizes, color options, and other configuration parameters may be user-configurable. A user may also be able to specify input and/or output trays and the use of automatic document feeders to allow batch processing of documents. Users may also be able to log into a printing device 160 to perform administrative functions such as to enable software or firmware on printing device 160 to perform various functions. In some embodiments, the log in process may require a password or other user-authentication mechanism.

In some embodiments, output trays may be secure, include an electronic locking mechanism, and may be locked by default. Users who print to one of the secure output trays may be prompted to enter a user-id and/or password or present other authenticating information in order to unlock the output trays and gain access to the printed documents. In some embodiments, users may be able to select accessible secure trays to print documents based on security levels associated with their user-id and/or the document being printed. For example, a user may be able to select a secure output tray associated with the user's security level and print to that tray.

In some embodiments, tray unlocking may be accomplished by entering the user-id, password, and/or other authenticating information using print consoles 190-1 or 190-2 by invoking appropriate menu options. In some embodiments, each tray may have local console 190-4 to allow users to enter information to unlock the tray. In some embodiments, biometric identification device 195-2 could be used to identify users. For example, printer 160 may include biometric identification device 195-2, which can be a fingerprint reader. Biometric identification device 195-2 may be used to read a fingerprint of the user's forefinger (or any other finger), which may then be compared with a stored fingerprint pattern for the user. If the fingerprints match, one or more trays to which the user may have printed documents may be unlocked.

In some embodiments, printers 160 may include additional configurable security features. For example, one or more output trays in printers 160 may be secure. Secure output trays may be configured by an administrator or may be dynamically assigned to a security level. For example, in one embodiment, an administrator could assign a security level to each tray in a printer. Users with a security level greater than the level assigned to a tray may be able to print to the tray.

A security level can be a label attached to a security classification in any security hierarchy. Accordingly, for the purposes of this discussion, labels associated with entities calling for more protection are seen as having a higher security level than entities with less protection, which have lower security levels. Entities may include users, documents and/or secure output trays. If the entity is a user, then the user with a higher security classification may have greater rights to some protected entities than users with a lower security classification. Therefore, the use of the term higher and lower in the context of the security level refers to the classification of the security level and not to the label or other nomenclature attached to the security level. Thus, for example, a first entity with a security level 2 may have a higher security level than a second entity with security level 7, if the entity with security level 1 is more secure than the entity with security level 7. Accordingly, users with a security level greater than 7 but less than 2 may be able to access the second entity but not the first.

Security levels can be labeled using any combination of letters, numbers, symbols, and/or other types of characters depending on the classification scheme used by the security system. For the purposes of this discussion, the rights allocated to, or protection associated with, entities assigned a specific security level may be obtained by appropriate queries and/or interaction with interfaces to the underlying security system. Techniques to obtain this information may be described in the documentation accompanying the security system. Accordingly, for the purposes of this discussion, a device, program, or component of system 100 that is being asked for access to a document in a secure output tray may simply request rights information associated with the security level of the entity requesting access from the underlying security system. If access is granted the security level of the entity requesting access may be deemed as sufficient or “not lower than” the security level of the document in the secure output tray. If access is not granted, the security level of the entity requesting access may be deemed as insufficient or “lower than” the security level of the document in the secure output tray. Thus, in some embodiments, system 100 may be indifferent to the details underlying the implementation of the security system. In some embodiments, one or more components of system 100 may maintain a list of documents in a secure tray sorted by security levels associated with the documents and/or their users.

In another embodiment, trays may be dynamically assigned to a security level. When a secure output tray has no printed documents, it may be assigned to any security level. If a user prints with security level S prints to a secure output tray with no documents, the secure output tray may be dynamically assigned to the security level S. Accordingly, in some embodiments, users with security levels lower than S may be unable to use or access this secure output tray until the user with security level S retrieves printed documents from the secure output tray. Similarly, if a secure output tray already contains printed documents, the output tray may be dynamically assigned to the highest of the security levels of the users with documents in the secure output tray.

When users with the highest security level among the users with documents in the tray have retrieved their documents, the security level assigned to the tray can be lowered to the security level equal to the highest security level of users with the documents remaining in the tray. The process can be repeated as the users continue to retrieve their documents. Accordingly, in such embodiments users may be allowed to retrieve documents from the tray in descending order of security levels. Because access to output trays is secured, a printer can detect when a document associated with a user is retrieved. For example, when a user enters a password for access to a secure output tray, printer 160-2 may infer that documents associated with that user and present in that tray have been retrieved. In some embodiments, sensors on the trays may detect if the secure output tray has been physically opened before inferring that any documents associated with the user in that tray have been retrieved.

For example, in one embodiment, when a secure output tray receives its first printed document, it is dynamically assigned the security level associated with the user performing the printing. Before the first document is retrieved by its user, any other users with a security level exceeding that of the first user may also print to the same secured output tray by explicitly selecting the tray. As documents are retrieved by their respective users, the security level of the output tray may be dynamically adjusted to the highest of the security levels of users with documents in that tray. When all documents have been retrieved by their respective users from an output tray, the tray can be reassigned to any security level.

A computer software application consistent with the present invention may be deployed on any of the exemplary computers, or printers as shown in FIG. 1. For example, computing device 110 could execute software that may control and/or monitor the operation of printer 160-1. An independent application may also execute concurrently on printer 160-2 based on its configuration. In another example, an application resident on print controller 175-1 could be configured using computer 110 but execute on printing device 160-1. In general, applications may execute in whole or in part on one or more computers, print controllers, or printers in the system. The embodiments described above are exemplary only and other embodiments and implementations will be apparent to one of reasonable skill in the art.

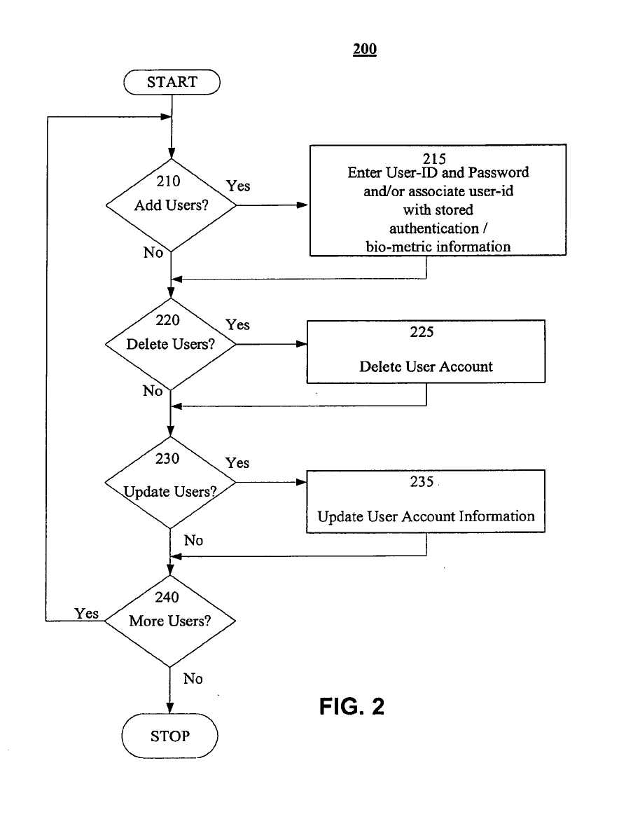

FIG. 2 shows a flowchart depicting steps in an exemplary method 200 for initialization of a system for secure printing. In some embodiments, the steps in method 200 may be performed by a system administrator. In some embodiments, a user-interface or other software may be provided to a system administrator to perform the initialization. For example, the user-interface may communicate with a system configuration utility that configures printers 160. User information that is added, deleted, and/or changed during method 200 may be stored in a database, which may be a secure database. For example, the database may be stored on server 130 and printers 160 may query the database for user and other information. In some instances, the database may be copied to secure locations on printers 160 when initialization has been completed.

After start-up, in step 210, the administrator is queried on new users being added to the system. If there are new users to be added, then, in step 215, the administrator may add a user-id and password corresponding to a new user. In some embodiments, other user authentication information may be used. For example, biometric information such as a stored fingerprint, retinal scan, or other information provided by the user being added may be associated with the user-id instead of, or in addition to, the password. If there are no users to be added, the algorithm proceeds to step 220.

In step 220, the administrator is queried on users being deleted from the system. If there are users being deleted, then, in step 225, the administrator may delete the user-id and associated information from the system. For example, information associated with the user-id being deleted may be purged from the database. If there are no users being deleted, the algorithm proceeds to step 230.

In step 230, the administrator is queried whether any user information is being updated. If there are updates to user information, in step 235, the administrator may update information associated with the user-id. For example, the password may be updated, the user's security level may be changed, and/or new bio-metric information provided by the user may be associated with the user-id. In some embodiments, a user may be permitted to update a limited subset of information associated with his or her user-id. For example, users may be allowed to change their passwords. If no user information is being updated, then the algorithm iterates proceeds to step 240.

In step 240, the algorithm determines if there are additional users to process. If so, the algorithm iterates and proceeds to step 210. If the current batch of users has been processed then the algorithm terminates. In some embodiments, information pertaining to users to be added, deleted, and updated may be placed in a file and run as a batch process without further human intervention.

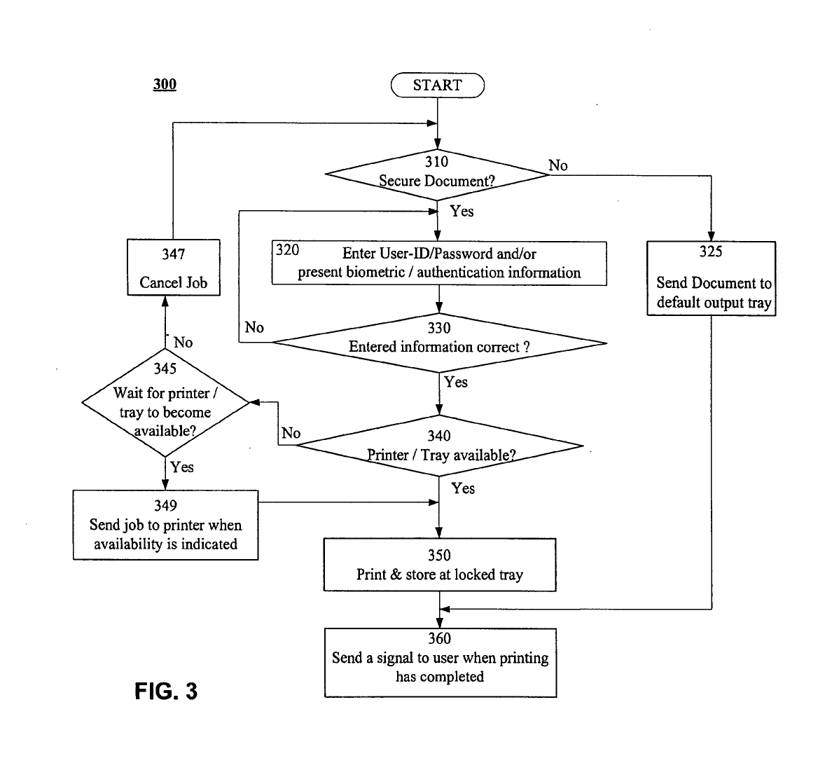

FIG. 3 depicts a flowchart describing an exemplary method 300 for securely printing documents. Exemplary method 300 may be invoked by user-interface associated with a printer driver running on computers 110 at the time of document printing. In step 310, properties associated with the document being printed may be inspected to determine if the document is secure. For example, printer driver software may determine a security level associated with a document from document properties, or from a user profile, when the document is printed by the user from a print menu in document processing software. If the document is a secure document, then the document may be associated with the security level of the user, or some other specified level, and can be printed to secure trays on printers 160. If the document is not a secure document, then it may be printed to the default unsecured output tray in step 325.

In step 320, the user may be prompted to enter user-id and password information. For example, the user-id and password information may be requested by the printer driver to ensure that the print request originates from an authorized user thus preventing unauthorized users from printing documents from temporarily unattended user terminals. In some embodiments, the user may be requested to provide bio-metric information or other authentication information instead of, or in addition to, the user-id and password. For example, the user's fingerprint may be scanned by biometric identification device 195-1 coupled to computer 110.

The entered information is verified by computer 110, in step 330. For example, computer 110 may verify the information by using a local database or by requesting information from server 130 through network 140. In some embodiments, communication between computer 110 and server 130 to verify user information may be encrypted. If the entered information is correct the user may select printer 160 and/or a secure tray for printing and may be asked to provide an additional password specific to the document. In one embodiment, the security data associated with the document such as the password and security level may default to the user's security level and password, respectively. For example, the user's log-in password may be associated with the document being printed. If the entered information is incorrect, the user may be asked to repeat the process. In some embodiments, repeated failures may result in suspension of the user-id and/or a notification to the system administrator or security personnel.

In step 340, the user may select printer 160 and/or a secure output tray to print the document. If printer 160 and/or the secure output tray are available then, in step 350, the document may be printed securely to the locked secure output tray on printer 160. To retrieve the document, the user can enter security information such as biometric information and/or a user-id and password on an input device coupled to printers 160 such as printer consoles 190-1 or 190-2. In some embodiments, the user-id and password may be entered using an input device coupled to the selected tray, such as console 190-4. In one embodiment, users may be authenticated by using biometric identification device 195-2 coupled to printer 160-2. If the security information obtained by the input device (biometric identification device 195-2 or consoles 190-1 and 190-2) matches some selected subset of security data associated with the document then the secure output tray may be unlocked to allow the user to retrieve printed documents. For example, if the password entered on console 195-1 by the user matches the password associated with the document then the secure output tray containing the document can be unlocked.

If printer 160 or secure trays on printer 160 are unavailable, the user may be presented with other options in step 345. Printers 160 may not be available for several reasons. Printer 160 may lack one or more resources, or be temporarily disabled, or a printer output tray corresponding to security level may be full, or all available printer output trays may already be assigned to other security levels. In such situations, the user may choose to delay or abort printing in step 345. For example, the user may be asked if the document should be held until the printer indicates availability. If the user chooses to wait, then in step 349, the document may be held until printer 160 indicates availability. When printer 160 and/or a tray are available, the document may be printed securely in step 350. In one embodiment, printer 160 may be polled periodically to determine if it is available. If the user chooses not to wait, printing of the document may be aborted.

In some embodiments, the user may prefer that a document be printed when the user is physically present at printer 160, even if printer 160 is currently available. In such situations, the user may be presented with an option to delay printing and the document will be sent to the printer with an indication that it should be queued and released when the user has entered security information such as a user-id and password, and/or presented biometric information at an input device coupled to printers 160 such as print consoles 190. When printing has been completed, the user may be notified in step 360.

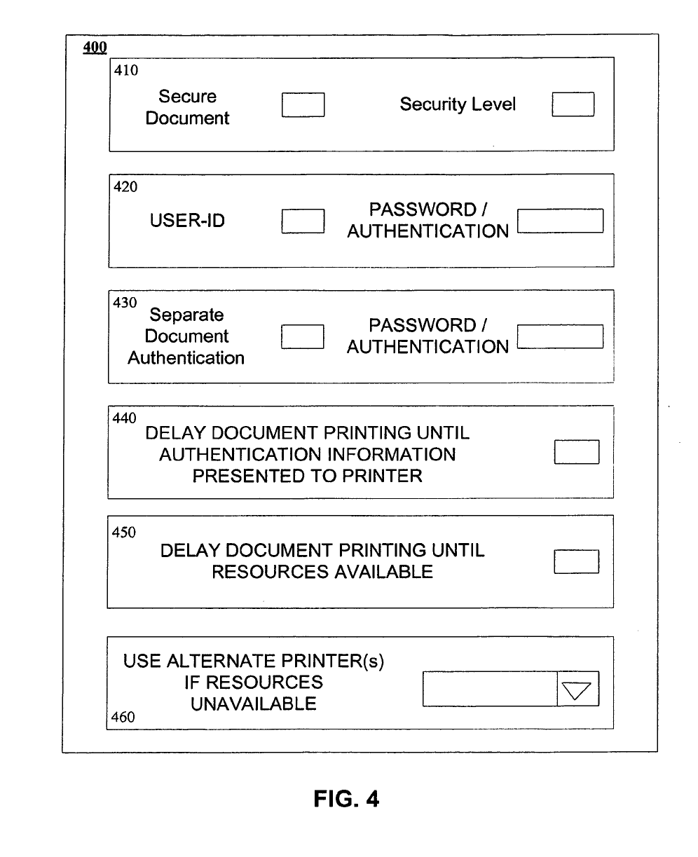

FIG. 4 depicts an exemplary user interface showing user configurable options in a system for securely printing documents. In exemplary box 410, the user may mark a document as secure and indicate its security level. In box 420, the user may enter a user-id and password, which will be verified before the document is sent for printing. In box 430, separate document specific authentication may be indicated and a document specific password may be set. In some embodiments, security information associated with a document such as a security level and password, may default to the users security level and password. In box 440, the user may specify that the document should be queued and held until the user has presented authentication information to an input device coupled to printers 160 such as print console 190. In box 450, the user may specify that the document should be spooled until print resources are available. In box 460, the user may specify an alternate printer, if the specified printer is unavailable. In some embodiments, the alternate printer may be specified using a drop down menu that lists other available printers.

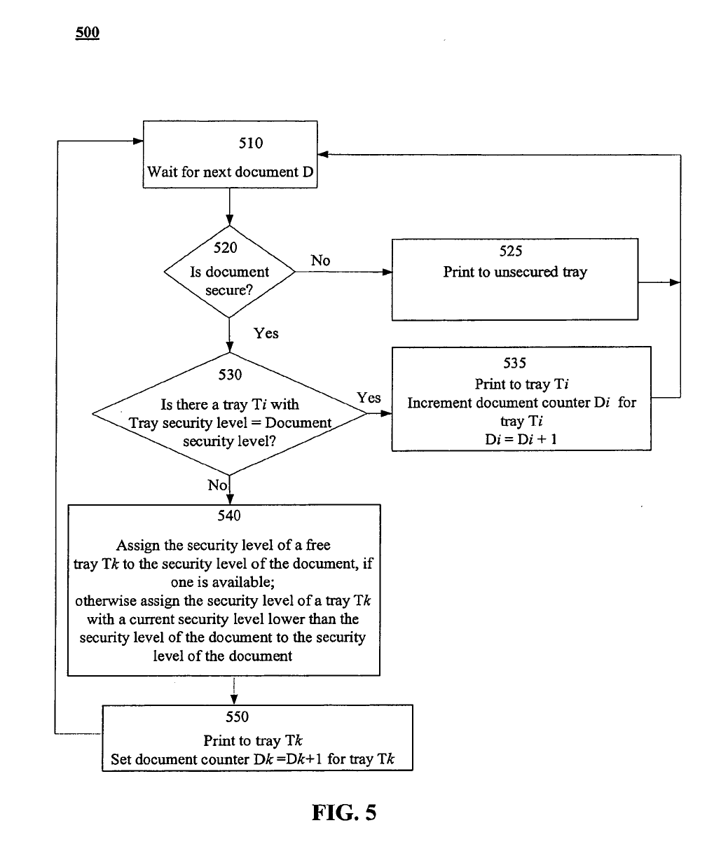

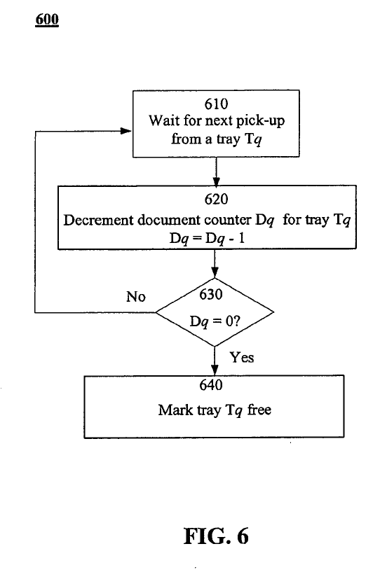

FIG. 5 and FIG. 6 show flowcharts 500 and 600, respectively, for portions of an exemplary method to dynamically assign security levels to output trays. The methods described in flowcharts 500 and 600 operate concurrently on a printer to dynamically assign security levels to output trays. In step 510, printer 160 waits for the next document to be printed. In step 520, job header information may be inspected to determine if the document is to printed securely.

If the document is not secure, it is printed in step 525 to an unsecured output tray. If the document is secure, then, in step 530, the algorithm determines if a tray on printer 160 has the same security level as that specified for the document. In one embodiment, the security level for the document may correspond to the security level of the user. In other embodiments, the security level may correspond to the document's security level for the document (for example, if the security level of the document is lower than the user's security level).

In step 535, if a tray Tᵢ on printer 160 has the same security level as document D then document D may be printed using output tray Tᵢ and the document count Dᵢ of tray Tᵢ is incremented by 1. The document count of a tray is the number of documents that have been printed to the tray but that have not been retrieved by a user as yet. If no tray on printer 160 has the same security level as document D then, in step 540, document D may be printed using any free output tray Tₖ that has not currently been assigned a security level, the security level of Tₖ may be set to the security level associated with the document, and the document count Dₖ of tray Tₖ is set to 1. If a free tray is unavailable, then document D may also be printed using any output tray Tₖ that has currently been assigned a security level lower than the document's security level. Next, in step 550, the security level of Tₖ may then be set to the security level associated with the document, and the document count Dₖ of tray Tₖ is set to Dₖ+1.

Referring now to FIG. 6, in step 610, the printer waits for the next user to retrieve a document from a tray T_{q}. When a document is retrieved from tray T_{q}, the document count D_{q} for tray T_{q} is decremented, in step 620. The user-id and password entered by users when retrieving documents from secure output trays can be correlated to specific documents. Whenever a user enters a user-id and password and/or provides biometric information, documents associated with the user are identified. Document counters for trays associated with those documents may then be decremented. In step 630, the document counter for D_{q} for tray T_{q} is checked to see if it is zero. When the document counter D_{q} for tray T_{q} is zero, the tray has no pending documents waiting to be retrieved and is free to be reassigned to any security level. Tray T_{q} may then be marked as free in step 640. If document counter D_{q} for tray T_{q} is non-zero, then the algorithm returns to step 610 to wait for the next document. The methods described by exemplary flowcharts 500 and 600 operate in parallel to dynamically assign security levels to trays on printer 160.

Further, methods consistent with embodiments of the invention may conveniently be implemented using program modules, hardware modules, or a combination of program and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the invention. Moreover, there are many computers and operating systems that may be used in practicing embodiments of the instant invention and, therefore, no detailed computer program could be provided that would be applicable to these many different systems. Each user of a particular computer will be aware of the language, hardware, and tools that are most useful for that user's needs and purposes.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware.

Embodiments of the present invention also relate to compute-readable media that include program instructions or program code for performing various computer-implemented operations based on the methods and processes of embodiments of the invention. The program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A printer comprising:
at least one secure output tray coupled to the printer, the at least one secure output tray associated with a first security level; and
at least one network port coupled to the printer, wherein the printer is capable of receiving at least one document and a first security data associated with the at least one document over the network port, and wherein the printer prints the received document to the secure output tray if a second security level derived from the first security data is not lower than the first security level.

2. The printer of claim 1, further comprising at least one input device coupled to the printer, wherein access to the secure output tray is governed by a second security level data associated with a second security data obtained by the input device.

3. The printer of claim 2, wherein the printer permits access to the secure output tray when the second security data matches a subset of the first security data.

4. The printer of claim 1, wherein the input device comprises a biometric identification device.

5. The printer of claim 1, wherein the input device comprises a console.

6. The printer of claim 1, wherein the network port is capable of receiving the first security data comprised of one or more of
a document security level;
a user-id and password; and
bio-metric information.

7. A method for printing at least one document securely comprising:
associating a first security data with the document;
transmitting the document and the first security data to a printer; and
printing the document to at least one secure output tray coupled to the printer, if a second security level derived from the first security data is not lower than a first security level currently associated with the secure output tray.

8. The method of claim 7, further comprising:
receiving a second security data; and
permitting access to the printed document in the secure output tray when the second security data matches a subset of the first security data.

9. The method of claim 8, wherein printing of the document occurs after the second security data matches a subset of the first security data.

10. The method of claim 7, wherein the first security data is encrypted prior to transmission.

11. The method of claim 7, wherein the first security data comprises one or more of:
a security level for the document;
a user-id and password; and
bio-metric information.

12. The method of claim 7, wherein the at least one secure output tray to which the document is printed is selected based on a security level associated with the document.

13. The method of claim 12, wherein the security level associated with the document is based on a security level associated with a user printing the document.

14. The method of claim 7, wherein the at least one secure output tray to which the document is printed is selected dynamically.

15. The method of claim 14, wherein dynamically selecting the at least one secure output tray further comprises:
incrementing a document counter for the selected secure output tray, wherein secure output tray selection further comprises:
selecting a secure output tray to print the document, if the security level for the secure output tray is equal to the security level for the document;
selecting a free secure output tray to print the document, if a free secure output tray is available; and
selecting a secure output tray to print the document where the security level for the secure output tray is less than the security level for the document otherwise;
decrementing the document counter for a secure output tray when a document in the tray is retrieved; and
marking all trays with a zero document count as free.

16. The method of claim 8, wherein the second security data comprises one or more of:
a user-id and password; and
user bio-metric information.

17. The method of claim 8, wherein receiving a second security data further comprises obtaining second security information from an input device coupled to the printer.

18. The method of claim 17, wherein the input device comprises one or more of:
a biometric identification device; and
a console.

19. A system comprising:
a computer capable of processing at least one document and associating a first security data with the document; and
at least one printer coupled to the computer over a network, wherein:
the printer is capable of receiving the document and the first security data associated with the document from the computer; and
printing the received document to at least one secure output tray coupled to the printer, if a second security level derived from the first security data is not lower than a first security level associated with the secure output tray.

20. The system of claim 19 further comprising an input device coupled to the printer, wherein the input device obtains a second security data that governs access to the secure tray.

21. The printer of claim 20, wherein the printer permits access to the secure output tray when the second security data matches a subset of the first security data.

22. The printer of claim 20, wherein the input device comprises a biometric identification device.

23. The printer of claim 20, wherein the input device comprises a console.
